(19) United States
(12) Patent Application Publication
(10) Pub. No.: US 2005/0185155 A1
(43) Pub. Date: Aug. 25, 2005

(54) Exposure apparatus and method

(76) Inventor: Yasuhiro Kishikawa, Utsunomiya-shi (JP)

Correspondence Address: MORGAN & FINNEGAN, L.L.P., 3 WORLD FINANCIAL CENTER, NEW YORK, NY, 10281-2101, US

(21) Appl. No.: 11/062,025

(22) Filed: Feb. 18, 2005

(30) Foreign Application Priority Data
Feb. 19, 2004 (JP) 2004-043524

(51) Int. Cl. G03B 27/52

(52) U.S. Cl. 355/30; 355/53

(57) ABSTRACT

An exposure apparatus includes a projection optical system for projecting a pattern of a reticle onto an object to be exposed, via a fluid that is at least partially filled in a space between the projection optical system and the object, and an adding unit for adding an additive to the fluid, the additive exhibiting an oxidation effect to an organic matter.

### BACKGROUND OF THE INVENTION

The present invention relates generally to an exposure apparatus and method, and more particularly to an exposure apparatus and method used to manufacture various devices including semiconductor chips such as ICs and LSIs, display devices such as liquid crystal panels, sensing devices such as magnetic heads, and image pickup devices such as CCDs, as well as fine patterns used for micromechanics. The present invention is suitable, for example, for a so-called immersion exposure apparatus (immersion lithography exposure system) that fills a space with fluid between the final surface of the projection optical system and the surface of the object, and exposes the object via the fluid.

A reduction projection exposure apparatus has been conventionally employed which uses a projection optical system to project a circuit pattern formed on a mask (reticle) onto a wafer, etc. to transfer the circuit pattern, in manufacturing such a fine semiconductor device as a semiconductor memory and a logic circuit in photolithography technology.

The minimum critical dimension to be transferred by the projection exposure apparatus or resolution is proportionate to a wavelength of light used for exposure, and inversely proportionate to the numerical aperture (“NA”) of the projection optical system. The shorter the wavelength is, the better the resolution is. Along with recent demands for finer semiconductor devices, a shorter wavelength of ultraviolet light has been promoted from a KrF excimer laser (with a wavelength of approximately 248 nm) to an ArF excimer laser (with a wavelength of approximately 193 nm). Currently, developments of the next generation light sources, such as an F₂ laser (with a wavelength of approximately 157 nm) and extremely ultraviolet (“EUV”) light, proceed.

With this background, an immersion exposure has attracted attentions as a method that uses the ArF laser and the F₂ laser for more improved resolution. The immersion exposure fills a space with the fluid between the final lens surface of the projection optical system and the image surface of the wafer (or arranges the fluid as a medium at a wafer side of the projection optical system). The immersion exposure shortens the effective wavelength of the exposure light, enlarges the apparent NA of the projection optical system, and improves the resolution.

In the immersion exposure, diffusions of the exposure light due to fine bubbles residues in the fluid between the final lens surface and the wafer's image surface affect the imaging performance. Accordingly, the instant assignee has already proposed an exposure apparatus that uses the deaerated fluid as the immersion material, extends a fluid film area around the exposure area, and extinguishes gas bubbles before they enter the exposure area, preventing the deteriorated imaging performance resulting from the fine gas bubbles residues in the fluid. See, for example, Japanese Patent Applications Nos. 2003-383732 and 2003-422932.

However, due to the impurities, such as an organic matter, exist in the fluid, the organic contaminants form a coating on a surface of the gas bubble and prevent the gas in the gas bubble from diffusing in the fluid, elongating the life of the gas bubble (which is a time period necessary for a generated gas bubble to extinguish due to the diffusion). Therefore, with the impurities, such as an organic matter, in the fluid as the immersion material, the exposure apparatus proposed in Japanese Patent Applications Nos. 2003-383732 and 2003-422932 cannot extinguish bubbles before they enter the exposure area and may possibly deteriorate the imaging performance in some instances. Even when the impurities, such as an organic matter, are completely removed from the fluid, the organic matters dissolve from the photoresist on the wafer and then generate the impurities.

### BRIEF SUMMARY OF THE INVENTION

Accordingly, it is an illustrative object of the present invention to provide an exposure apparatus and method which removes fine gas bubbles and impurities, such as organic matters, from the fluid as the immersion material, and has good imaging performance.

An exposure apparatus according to one aspect of the present invention includes a projection optical system for projecting a pattern of a reticle onto an object to be exposed, via a fluid that is at least partially filled in a space between the projection optical system and the object, and an adding unit for adding an additive to the fluid, the additive exhibiting an oxidation effect to an organic matter.

An exposure apparatus includes a projection optical system for projecting a pattern of a reticle onto an object to be exposed, a fluid that is at least partially filled in a space between the projection optical system and the object, and an additive that is added to the fluid and exhibits an oxidation effect to an organic matter.

An exposure method includes the steps of adding to a fluid an additive having an oxidation effect to an organic matter, introducing the fluid into at least part of a space between a projection optical system and an object to be exposed, and projecting a pattern of a reticle onto the object via the projection optical system and the fluid.

A device manufacturing method according to another aspect of the present invention includes the steps of exposing an object using the above exposure apparatus, and developing the object exposed.

Other objects and further features of the present invention will become readily apparent from the following description of the preferred embodiments with reference to accompanying drawings.

### BRIEF DESCRIPTION OF THE DRAWINGS

FIG. 1 is a schematic block diagram of an exposure apparatus according to one aspect of the present invention.

FIG, 2 is a schematic block diagram showing one exemplary structure of a fluid supply mechanism shown in FIG. 1.

FIG. 3 is a schematic block diagram showing one exemplary generating and adding mechanisms shown in FIG. 2.

FIG. 4 is a schematic block diagram of a variation of the adding mechanism shown in FIG. 3.

FIG. 5 is a schematic block diagram of a structure of a variation of the exposure apparatus shown in FIG. 1.

FIG. 6 is a flowchart for explaining a method for fabricating devices (semiconductor chips such as ICs, LSIs, and the like, LCDs, CCDs, etc.).

FIG. 7 is a detailed flowchart for Step 4 of wafer process shown in FIG. 6.

### DETAILED DESCRIPTION OF THE PREFERRED EMBODIMENTS

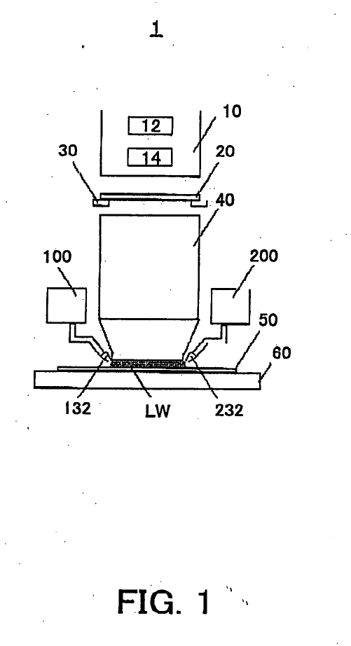

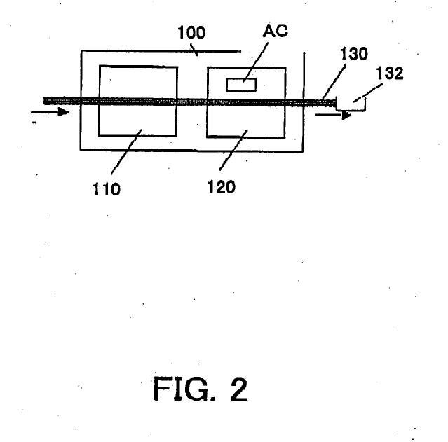

With reference to the accompanying drawings, a description will be given of the preferred embodiment of the present invention. Like elements in each figure are designated by the same reference numerals, and a duplicate description will be omitted. FIG. 1 is a schematic block diagram showing a structure of the inventive exposure apparatus 1.

The exposure apparatus 1 is an immersion projection exposure apparatus that exposes a circuit pattern of a reticle 20 onto an object 50 in a step-and-repeat or a step-and-scan manner, via fluid LW supplied to at least part of a space between a projection optical system 40's final surface and an object 50. Such an exposure apparatus is suitable for a sub-micron or quarter-micron lithography process. This embodiment exemplarily describes a step and scan exposure apparatus (which is also called “a scanner”). The “step-and-scan manner”, is used herein, is an exposure method that exposes a reticle pattern onto a wafer by continuously scanning the wafer relative to the reticle, and by moving, after an exposure shot, the wafer stepwise to the next exposure area to be shot. The “step-and-repeat manner” is another mode of exposure method that moves a wafer stepwise to an exposure area for the next shot, for every cell projection shot.

The exposure apparatus 1 includes, as shown in FIG. 1, an illumination apparatus 10, a reticle stage 30 mounted with a reticle 20, a projection optical system 40, a wafer stage 60 mounted with an object 50 to be exposed, a fluid supply mechanism 100, and a fluid recovery mechanism 200.

The illumination apparatus 10 illuminates the reticle 20 that has a circuit pattern to be transferred, and includes a light source section 12 and an illumination optical system 14.

As an example, the light source section 12 uses a light source such as an ArF excimer laser with a wavelength of approximately 193 nm and a KrF excimer laser with a wavelength of approximately 248 nm. However, the laser type is not limited to excimer lasers because for example, an F₂ laser with a wavelength of approximately 157 nm may be used. Similarly, the number of laser units is not limited. An optical system (not shown) for reducing speckles may swing linearly or rotationally on the optical path. When the light source section 12 uses a laser, it is desirable to employ a beam shaping optical system that shapes a parallel beam from a laser source to a desired beam shape, and an incoherently turning optical system that turns a coherent laser beam into an incoherent one. A light source applicable for the light source section 12 is not limited to a laser, and may use one or more lamps such as a mercury lamp and a xenon lamp.

The illumination optical system 14 is an optical system that illuminates the reticle 20, and includes a lens, a mirror, an optical integrator, a stop and the like, for example, a condenser lens, a fly eye lens, an aperture stop, a condenser lens, a slit, and an imaging optical system in this order. The illumination optical system 14 can use any light regardless of whether it is axial or non-axial light. The light integrator may include a fly-eye lens or an integrator formed by stacking two sets of cylindrical lens array plates (or lenticular lenses), and can be replaced with an optical rod or a diffractive element.

The reticle 20 is made, for example, of quartz, has a circuit pattern (or an image) to be transferred, and is supported and driven by a reticle stage 30. Diffracted light emitted from the reticle 20 passes through the projection optical system 40 and is then projected onto the object 50. The reticle 20 and the object 50 are located in an optically conjugate relationship. Since the exposure apparatus 1 of this embodiment is a scanner, the reticle 20 and the object 50 are scanned at the speed ratio of the reduction ratio, thus transferring the pattern from the reticle 20 to the object 50. If it is a step and repeat exposure apparatus (referred to as a “stepper”), the reticle 20 and the object 50 remain still during exposure.

The reticle stage 30 supports the reticle 20 via a reticle chuck (not shown), and is connected to a moving mechanism (not shown). A moving mechanism (not shown) may include a linear motor etc., drives the reticle stage 30 ih XYZ-axes directions and rotating directions around these axes, and moves the reticle 20. Here, the Y axis is a scan direction within a surface of the reticle 20 or the object 50, the X axis is a direction perpendicular to the Y axis. The Z axis is a direction perpendicular to the surface of the reticle 20 or the object 50.

The projection optical system 40 serves to image diffracted light that passes a pattern of the reticle 20 on the object 50. The projection optical system 40 may use an optical system comprising solely of a plurality of lens elements, a (catadioptric) optical system including a plurality of lens elements and at least one concave mirror, an optical system including a plurality of lens elements and at least one diffractive optical element such as a kinoform, a full mirror type optical system, and so on. Any necessary correction of the chromatic aberration may be accomplished by using a plurality of lens units made from glass materials having different dispersion values (Abbe values) or arranging a disfractive optical element such that it disperses light in a direction opposite to that of the lens unit.

The object 50 is a wafer in this embodiment, but may cover a LCD and another object to be exposed. Photoresist is applied to the object 50.

The wafer stage 60 supports the object 50 via a wafer stage (not shown). Similar to the reticle stage 30, the wafer stage 60 uses a linear motor to move the object 50 in the XYZ-axes directions and rotating directions around these axes. The positions of the reticle stage 30 and wafer stage 60 are monitored, for example, by a laser interferometer and the like, and these stages are driven at a constant speed ratio. The wafer stage 60 is installed on a stage stool supported on the floor and the like, for example, via a dampener. The reticle stage 30 and the projection optical system 40 are installed on a barrel stool (not shown), for example, via a dampener, to the base frame placed on the floor.

The fluid supply mechanism 100 supplies the fluid LW between the projection optical system 40 and the object 50. The fluid supply mechanism 100 includes, as shown in FIG. 2, a generating mechanism 110, an adding mechanism 120, and a pipe 130. Here, FIG. 2 is a schematic block diagram showing a structure of the fluid supply mechanism 100.

The generating mechanism 110 serves to generate the fluid LW as the immersion material. This embodiment uses the pure water for the fluid LW. However, the fluid LW is not limited to the pure water, and may use any fluids as long as they have high transmittance and refractive index characteristics to the exposure light's wavelength and are chemically stable to the projection optical system 40 and the photoresist applied onto the object 50. For example, the fluorine inert fluid or organic fluid having a high retractive index can be used.

The adding mechanism 120 serves as the adding means for adding an additive AC to the fluid. The adding mechanism 120 also serves to control the addition amount of the additive AC, as described later. This embodiment uses ozone for the additive AC. The present invention does not limit the material used as the additive AC to ozone, but may use any materials as long as they exhibit an oxidation (or decomposition) effect to the organic matter.

The pipe 130 flows the fluid LW generated by the generating mechanism 110 and the fluid LW to which the additive AC is added by the adding mechanism 120, for example, in the arrow direction in FIG. 2, and supplies the fluid LW via the supply nozzle 132 attached to the tip. The pipe 130 is made of a material that is unlikely to contaminate the fluid and has a good durability to the additive AC, such as ozone. Such a material is, for example, a fluorine resin.

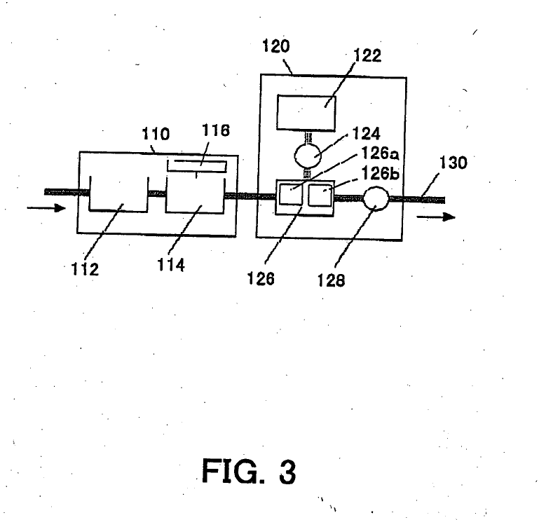

FIG. 3 shows one example of the generating mechanism 110 and the adding mechanism 120. Referring now to FIG. 3, a description will be given of control of the addition amount of the additive AC to be added to the fluid LW. The generating mechanism 110 includes, as shown in FIG. 3, an extrapure water generator means 112, a degassing means 114, and a control means 116.

The extrapure water generator means 112 reduces impurities, such as metal ions, fine particles and organic matters contained in the material water supplied from a material water supply source (not shown), and prepares the fluid LW. The fluid LW of this embodiment is preferably the extrapure water containing particles at a concentration of several particles/mL or less, which have a specific resistance value of 18 MΩ·cm or greater and a particle size of 0.05 μm or greater (“extrapure water HW” hereinafter).

The extrapure water HW prepared by the extrapure water generator means 112 is supplied to the degassing means 114 via the pipe 130. The degassing means 114 reduces the dissolved oxygen and nitrogen in the fluid LW. The degassing means has the degassing performance of 80% or greater to the saturated state of the dissolved oxygen (about 9 ppm) and the saturated state of the dissolved nitrogen (about 14 ppm).

The control means 116 serves to control the dissolved oxygen amount and dissolved nitrogen amount in the fluid LW via the degassing means 114. Preferably, the dissolved oxygen amount and dissolved nitrogen amount in the fluid LW are as small as possible, although the control means 116 controls the dissolved oxygen amount in the fluid LW to 1.8 ppm or less and the dissolved nitrogen amount to 2.8 ppm or less.

The deaerated extrapure water HW as the immersion material generated by the generating mechanism 110 is supplied to the adding mechanism 120 via the pipe 130. The adding mechanism 120 includes, as shown in FIG. 3, an additive generator means 122, a detector means 124, a control mechanism 126, and an addition amount detector means 128.

In generating the fluid LW that is the deaerated extrapure water HW generated by the generating mechanism 110 to which the additive AC (which is ozone OC) generated by the additive generator means 122 is added, the adding mechanism 120 controls the addition amount of the additive AC through the control mechanism 126. More specifically, the control mechanism 126 controls the addition amount of the additive AC dissolved in the fluid LW to 20% or less of the saturated concentration of the additive AC to the fluid LW.

This embodiment may use any means for the additive generator means 122 as long as it can generate the ozone OC, such as a silent discharge method that generates the ozone OC by introducing the air and oxygen in the silent discharges, a hydrolysis method that generates the ozone OC by hydrolyzing the pure water, and a UV irradiating method.

Tho detector means 124 detects an amount of the additive AC generated by the additive generator means 122. The detector means 124 in this embodiment detects an amount of ozone OC generated by the additive generator means 122.

The control mechanism 126 includes, for example, a pressure controller 126a that dissolves the ozone OC generated by the additive generator means 122, in the extrapure water HW under the pressure controlled condition. The pressure controller 126a controls the addition amount of the ozone OC by compressing the ozone OC generated by the additive generator means 122 so that it is always higher than the normal pressure or by compressing the extrapure water HW itself. The pressure controller 126a is preferably a pressurized pump that uses a ozone-proof material.

The control mechanism 126 may include a temperature controller 126b that dissolves the ozone OC generated by the additive generator means 122, in the extrapure water HW under the temperature controlled condition. The temperature controller 126b controls the addition amount of the ozone OC by controlling the temperature of the ozone OC generated by the additive generator means 122 or the temperature of the extrapure water HW.

The control mechanism 126 has upper and lower limits of the concentration of the ozone water resulting from the ozone OC added extrapure water HW. The upper limit concentration is determined so that the photoresist applied to the object 50 does not chemically reacts, and so that the concentration of in the dissolved gas is unlikely to affect the life of the gas bubble, i.e., a time period necessary for the generated gas bubble to extinguish due to the diffusion. The lower limit of the concentration is a concentration corresponding to the decomposition capability of impurities, such as an organic matter. Thus, the addition amount of the ozone OC added to the extrapure water HW or the ozone concentration is adjusted to the optimal concentration in the control mechanism 126.

The addition amount detector means 128 detects an addition amount of the additive AC added by the control mechanism 126. The additive amount detector means 128 in this embodiment detects the addition amount of the ozone OC added to the extrapure water HW or the ozone concentration. The control mechanism 126 provides a feedback control of the addition amount of the additive AC based on the addition amount detected by the addition amount detector means 128.

The fluid recovery mechanism 200 recovers, via a recovery nozzle 232, the additive AC added and temperature controlled fluid LW that is supplied to a space between the projection optical system 40's final surface and the object 50.

The thus configured exposure apparatus 1 fills the space between the projection optical system 40's final surface and the object 50 with the fluid LW as the ozone water during exposure. The ozone water is maintained to the concentration and temperature controlled state of the extrapure water HW highly purified and deaerated by the generating mechanism 110, to which the additive AC as the ozone OC is added by the adding mechanism 120.

The ozone water as the fluid LW utilizes the oxidation effect of the ozone OC, decomposes and removes the impurities, such as an organic matter, which film the gas bubbles' surfaces in the fluid LW. This configuration promotes the gas in the gas bubble to diffuse in the fluid LW, and prevents an elongation of the life of the gas bubble, i.e., a time period necessary for the generated gas bubble to extinguish due to the diffusion. Thus, the exposure apparatus 1 can reduce the influence on its imaging performance by the diffusion of the exposure light resulting from the gas bubbles.

While the ozone water as the fluid LW effectively removes the impurities, such as an organic matter, adhered to the gas bubble surface in the fluid LW, the fluid LW also removes the impurities, such as an organic matter, adhered to the lens surface in the projection optical system 40 and the surface of the object 50. A decomposition and removal of the impurities, such as an organic matter adhered to the lens surface in the projection optical system 40 and the surface of tho object 50 can reduce the influence of the non-uniform light intensity distribution on the image surface relative to the imaging performance to the exposure apparatus 1.

The ozone water as the fluid LW has an effect of using high oxidation/reduction potentials of the ozone to prevent absorptions of the metallic impurities to the lens surface in the projection optical system 40 and the surface of the object 50.

In exposure, the light is emitted from the light source section 12, e.g., Koehler-illuminates the reticle 20 via the illumination optical system 14. The light that passes the reticle 20 and reflects the reticle pattern is imaged onto the object 50 via the projection optical system 40 and the fluid LW. The fluid LW used for the exposure apparatus 1 reduces the diffusion of the exposure light resulting from the gas bubbles residues in the fluid LW and contaminations of the lens surfaces of the projection optical system 40 etc., and prevents the deterioration of the imaging performance due to the non-uniform intensity distribution on the imaging surface. Therefore, the exposure apparatus 1 exposes a pattern of the reticle 20 with extremely high resolving power.

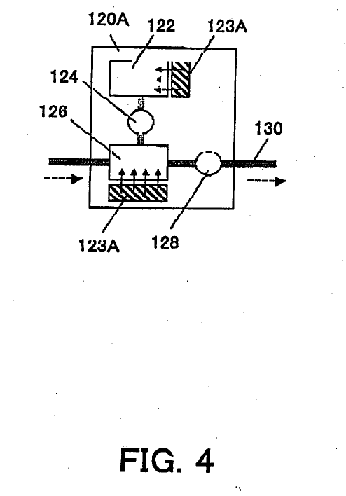

FIG. 4 is a schematic block diagram showing a structure of an adding mechanism 120A as a variation of the adding mechanism 120. The adding mechanism 120A is different from the adding mechanism 120 in that the adding mechanism 120A includes an irradiation means 123A. The adding mechanism 120A includes, as shown in FIG. 4, the additive generator means 122, the irradiation means 123A, the detector means 124, the control mechanism 126, and the addition amount detector means 128.

The irradiation means 123A irradiates the UV light to the ozone OC generated by the additive generator means 122. In FIG. 4, a solid line arrow designates an irradiation direction of the UV light. The irradiation means 123A is a UV light source in this embodiment, but is not limited to this embodiment as long as it can generates active oxygen atoms from the ozone OC or oxygen, such as a low-pressure mercury lamp (with wavelengths of about 254 nm and about 185 nm) and a xenon excimer lamp light source (with a wavelength of about ½ nm). The light having a wavelength smaller than 175 nm directly decomposes oxygen, and generates the active oxygen atoms. Therefore, a xenon excimer lamp is preferable since it can irradiate the light having a wavelength smaller than that of the low-pressure mercury lamp. However, the air absorbs 90% of the excimer light having a wavelength of 172 nm when it proceeds only by 8 mm. Therefore, the part that contacts the air is preferably replaced with the inert gas, such as nitrogen, for effective use of the excimer light. In order to irradiate the UV light onto the ozone OC, a window member etc. for connecting the irradiation means 123A and the additive generator means 122 are preferably made of quartz, etc. which has high transmittance characteristic in the UV range.

The adding means 120A in this embodiment uses the irradiation means 123A to irradiate the UV light to the ozone OC generated by the additive generator means 122, and uses the control mechanism 126 to add the active oxygen atoms to the fluid LW. The active oxygen atoms have a greater oxidation power than the ozone OC, and improve the decomposition and removal effects of the organic matter etc. In addition, the irradiation means 123A may be added to the control mechanism 126 as shown in FIG. 4, and the control mechanism 126 may generate the active oxygen atoms from the ozone OC and dissolved oxygen in the fluid LW by irradiating the UV light to the ozone OC added fluid LW.

The fluid LW in this embodiment utilizes the oxidation effects of the ozone OC and active oxygen atoms, decomposes and removes the impurities, such as an organic matter, which film the gas bubbles' surfaces in the fluid LW. This configuration promotes the gas in the gas bubble to diffuse in the fluid LW, and prevents an elongation of the life of the gas bubble, i.e., a time period necessary for the generated gas bubble to extinguish due to the diffusion. Thus, the exposure apparatus 1 can reduce the influence on its imaging performance by the diffusion of the exposure light resulting from the gas bubbles.

While the fluid LW in this embodiment effectively removes the impurities, such as an organic matter, adhered to the gas bubble surface in the fluid LW, the fluid LW also removes the impurities, such as an organic matter, adhered to the lens surface in the projection optical system 40 and the surface of the object 50. A decomposition and removal of the impurities, such as an organic matter adhered to the lens surface of the projection optical system 40 and the surface of the object 50 can reduce the influence of the non-uniform light intensity distribution on the image surface relative to the imaging performance of the exposure apparatus 1.

The fluid LW in this embodiment has an effect of using high oxidation/reduction potentials of the ozone to prevent absorptions of the metallic impurities to the lens surface in the projection optical system 40 and the surface of the object 50.

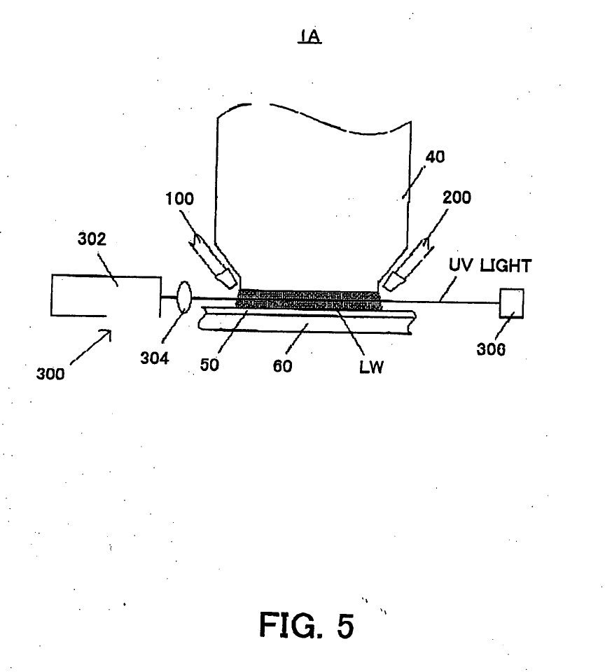

FIG. 5 is a schematic block diagram showing a structure of an exposure apparatus 1A as a variation of the exposure apparatus 1. The exposure apparatus 1A is different from the exposure apparatus 1 in that the exposure apparatus 1A includes an irradiation means 300. FIG. 5 shows only elements around the irradiation means 300.

The irradiation means 300 irradiates the UV light onto the fluid LW interposed between the projection optical system 40 and the object 50. The irradiation means 300 includes, as shown in FIG. 5, a UV light source 302, a light shaping means 304, and a light shielding plate 306.

The UV light source 302 emits the UV light to be irradiated onto the fluid LW that is interposed between the projection optical system 40 and the object 50. The UV light source is not limited, as long as it can generate the active oxygen atoms from the ozone OC and oxygen, such as a low-pressure mercury lamp (with wavelengths of about 254 nm and about 185 nm) and a xenon excimer lamp light source (with a wavelength of about 172 nm). The light having a wavelength smaller than 175 nm directly decomposes oxygen, and generates the active oxygen atoms. Therefore, a xenon excimer lamp is preferable since it can irradiate tho light having a wavelength smaller than that of the low pressure mercury lamp. However, the air absorbs 90% of the excimer light having a wavelength of 172 nm when it proceeds only by 8 mm. Therefore, the part that contacts the air is preferably replaced with the inert gas, such as nitrogen, for effective use of the excimer light.

The light shaping means 304 converts the light emitted from the UV light source 302 into a desired shape. The light shaping means 304 includes at least one optical element, and converts the incident light's shape into the desired shape. A shape of the exit light is not limited as long as it uniformly illuminates the exposure area of the fluid LW that is interposed between the projection optical system 40 and the object 50. Nevertheless, the divergent incident UV light exposes some types of photoresists applied onto the object 50, and thus the UV light is preferably converted into a sheet shape so as to prevent the UV light from exposing the photoresist.

The light shielding plate 306 is emitted from the UV light source 302, and shields the UV light that has passed the fluid LW. The light-shielding plate 306 may be replaced with the photodetector that detects the UV light. For example, this photodetector detects the diffusion intensity of the light emitted form the UV light source 302 during exposure for real-time detections of the influence by the gas bubbles etc. in the fluid LW, and the feedback control by the control mechanism 126.

The exposure apparatus 1A irradiates, via the light shaping means 304, the UV light emitted from the UV light source 302 onto the fluid LW that is interposed between the projection optical system 40 and the object 50, and generates the active oxygen atoms from the ozone OC and dissolved oxygen contained in the fluid LW. In particular, the exposure apparatus 1A directly irradiates the UV light onto the fluid LW in the exposure area, and locally generates the active oxygen atoms, effectively removing the impurities, such as an organic matter, from the exposure area.

The exposure apparatus 1A utilizes the oxidation effects of the ozone OC and active oxygen atoms in the fluid LW, decomposes and removes the impurities, such as an organic matter, which film the gas bubbles' surfaces in the fluid LW. This configuraiton promotes the gas in the gas bubble to diffuse in the fluid LW, and prevents an elongation of the life of the gas bubble, i.e., a time period necessary for the generated gas bubble to extinguish due to the diffusion. Thus, the exposure apparatus 1A can reduce the influence on its imaging performance by the diffusion of the exposure light resulting from the gas bubbles.

While the fluid LW used for the exposure apparatus 1A effectively removes the impurities, such as an organic matter, adhered to the gas bubble surface in the fluid LW, the fluid LW also removes the impurities, such as an organic matter, adhered to the lens surface in the projection optical system 40 and the surface of the object 50. A decomposition and removal of the impurities, such as an organic matter adhered to the lens surface in the projection optical system 40 and the surface of the object 50 can reduce the influence of the non-uniform light intensity distribution on the image surface relative to the imaging performance of the exposure apparatus 1A.

The fluid LW used for the exposure apparatus 1A also has an effect of using high oxidation/reduction potentials of the ozone OC in the fluid LW to prevent absorptions of the metallic impurities to the lens surface in the projection optical system 40 and the surface of the object 50.

According to the exposure apparatuses 1 and 1A, the additive AC having an oxidation effect is added to the fluid LW as the immersion material. A decomposition and removal of the impurities, such as an organic matter, which film the gas bubbles surfaces in the fluid LW, prevent an elongation of the life of the gas bubble, i.e., a time period necessary for the generated gas bubble to extinguish due to the diffusion. This configuration can prevent the deterioration of the imaging performance due to the diffusions of the exposure light resulting from the gas bubbles, and the resultant non-uniform light intensity distribution on the image surface. In addition, the above configuration is applicable to the impurities, such as an organic matter, adhered to the lens surface of the projection optical system and the surface of the object in the fluid LW. Therefore, the exposure apparatuses 1 and 1A can provide high-quality devices that are not affected by the imaging performance deteriorated by the gas bubbles and contaminations resulting from the impurities, such as an organic matter.

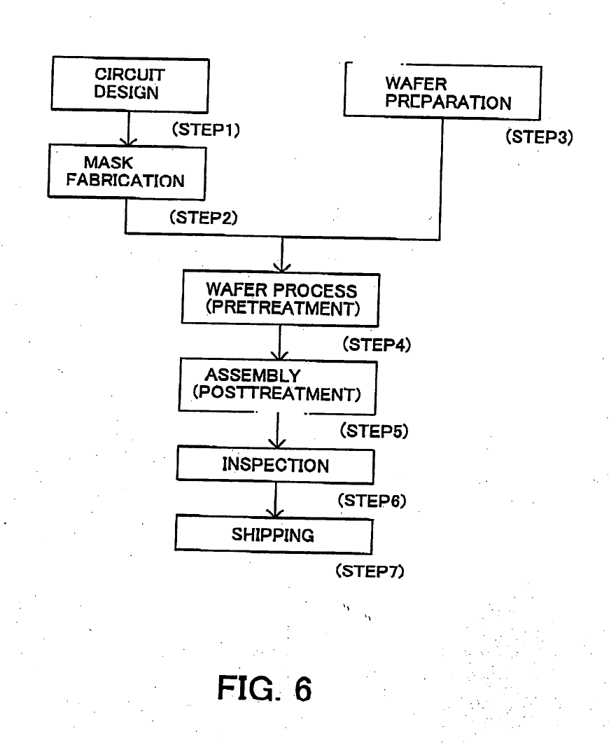

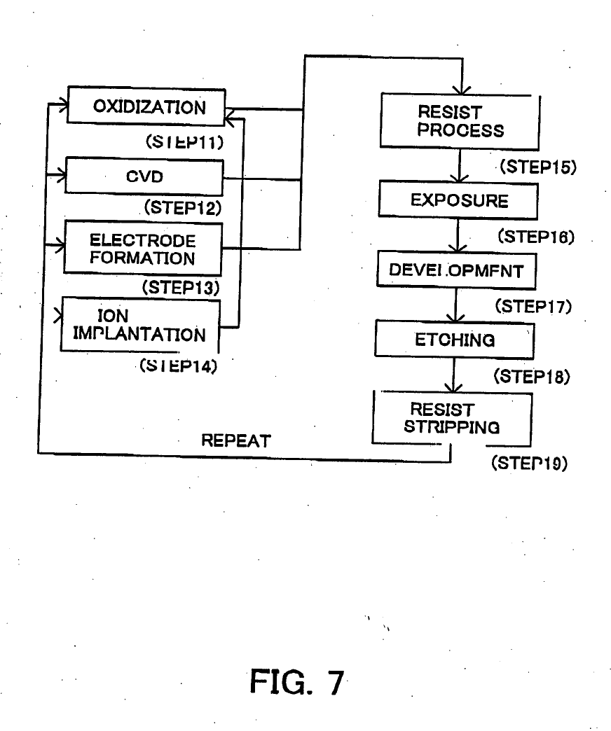

Referring to FIGS. 6 and 7, a description will now be given of an embodiment of a device fabricating method using the above exposure apparatus 1 or 1A. FIG. 6 is a flowchart for explaining a fabrication of devices (i.e., semiconductor chips such as IC and LSI, LCDs, CCDs, etc.). Here, a description will be given of a fabrication of a semiconductor chip as an example. Step 1 (circuit design) designs a semiconductor device circuit. Step 2 (mask fabrication) forms a mask having a designed circuit pattern. Step 3 (wafer preparation) manufactures a wafer using materials such as silicon. Step 4 (wafer process), which is referred to as a pretreatment, forms actual circuitry on the wafer through photolithography using the mask and wafer. Step 5 (assembly), which is also referred to as a post-treatment, forms into a semiconductor chip the wafer formed in Step 4 and includes an assembly step (e.g., dining, bonding), a packaging step (chip sealing), and the like. Step 6 (inspection) performs various tests for the semiconductor device made in Step 5, such as a validity test and a durability test. Through these steps, a semiconductor device is finished and shipped (Step 7).

FIG. 7 is a detailed flowchart of the wafer process in Step 4. Step 11 (oxidation) oxidize the wafer's surface. Step 12 (CVD) forms an insulating film on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatus 1 or 1A to expose a circuit pattern on the mask onto the wafer. Step 17 (development) develops the exposed wafer. Step 18 (etching) etches parts other than a developed resist image. Stop 19 (resist stripping) removes disused resist after etching. These steps are repeated, and multilayer circuit patterns are formed on the wafer. The device manufacture method of the present invention may manufacture higher quality devices than the conventional one. Thus, the device manufacturing method using the exposure apparatus 1 or 1A, and resultant devices themselves as intermediate and finished products also constitute one aspect of the present invention.

Thus, the present invention can provide an exposure apparatus and method which removes fine gas bubbles and impurities, such as organic matters, from the fluid as the immersion material, and has good imaging performance.

Further, the present invention is not limited to these preferred embodiments, and various modifications and changes may be made in the present invention without departing from the spirit and scope thereof.

This application claims a foreign priority based on Japanese Patent Application No. 2004-043524, filed Feb. 19, 2004, which is hereby incorporated by reference herein.

1. An exposure apparatus comprising:
a projection optical system for projecting a pattern of a reticle onto an object to be exposed, via a fluid that is at least partially filled in a space between said projection optical system and the object; and
an adding unit for adding an additive to the fluid, the additive exhibiting an oxidation affect to an organic matter.

2. An exposure apparatus according to claim 1, wherein said adding unit includes a control mechanism for controlling an addition amount of the additive to the fluid.

3. An exposure apparatus according to claim 2, wherein the control mechanism includes a pressure controller for controlling the addition amount by controlling a pressure of the additive or the fluid.

4. An exposure apparatus according to claim 2, wherein the control mechanism includes a temperature controller for controlling the addition amount by controlling a temperature of the fluid.

5. An exposure apparatus according to claim 2, wherein the control mechanism controls the addition amount to the fluid to be 20% of a saturated concentration of the fluid or smaller.

6. An exposure apparatus according to claim 1, wherein the additive is ozone.

7. An exposure apparatus according to claim 6, further comprising an irradiation unit for irradiating ultraviolet light to the ozone.

8. An exposure apparatus according to claim 1, further comprising an irradiation unit for irradiating ultraviolet light to the fluid.

9. An exposure apparatus according to claim 7, wherein the ultraviolet light to an excimer laser.

10. An exposure apparatus according to claim 8, wherein the ultraviolet light is an excimer laser.

11. An exposure apparatus according to claim 1, wherein the fluid is pure water or fluorine inert fluid or organic fluid.

12. An exposure apparatus according to claim 1, further comprising:
a degassing unit for degassing the fluid; and
a control unit for controlling a dissolved oxygen amount or a dissolved nitrogen amount via said degassing unit.

13. An exposure method comprising the steps of:
adding to a fluid an additive having an oxidation effect to an organic matter;
introducing the fluid into at least part of a space between a projection optical system and an object to be exposed; and
projecting a pattern of a reticle onto the object via the projection optical system and the fluid.

14. An exposure method according to claim 13, wherein said adding stop includes the step of controlling an addition amount of the additive based on a pressure of the fluid.

15. An exposure method according to claim 13, wherein said adding step includes the step of controlling an addition amount of the additive based on a temperature of the fluid.

16. A device manufacturing method comprising the steps of:
exposing an object to be exposed using an exposure apparatus according to claim 1; and
developing the object exposed.
